(19) United States
(12) Patent Application Publication
(10) Pub. No.: US 2013/0330233 A1
(43) Pub. Date: Dec. 12, 2013

(54) Electrochemical or electroless deposition of catalytic material on a non-catalytic fibrous substrate

(71) Applicant: Gregor Hsiao, San Jose, CA (US)

(72) Inventor: Gregor Hsiao, San Jose, CA (US)

(21) Appl. No.: 13/492,474

(22) Filed: Jun. 8, 2012

(51) Int. Cl. B01J 19/00; B01J 37/34; G01N 21/75; B01J 37/025

(52) U.S. Cl. 422/83; 422/211; 502/100; 502/5

(57) ABSTRACT

A catalyst is provided in the form of a fibrous wooly structure. The fibers of the wooly structure have a central non-catalytic core and an outer catalytic layer. An intermediate layer is sandwiched between the core and catalyst layer. Electrochemical or electroless deposition can be employed to fabricate such structures. In one experiment, Rhodium was deposited onto a steel wool substrate using Nickel as the intermediate layer.

### FIELD OF THE INVENTION

This invention relates to catalysts.

### BACKGROUND

Catalysts for gas phase reactions are typically referred to as heterogeneous catalysts, i.e. a different phase than the reactants. Such catalysts are typically fixed in a heated container and the reactant gas passes through the resulting catalyst ‘bed’. The commercially available forms include: monolith (a single large block of sintered catalyst pellets), pellets (typically extruded material having dimensions of several mm to cm), and fine powders (particle dimensions typically <50 microns). Maximum catalyst efficacy requires a high surface area so even the monoliths contain significant void fractions.

Catalysts in the form of fine solid catalyst wires are also known. For example, such wires can be woven or knitted to provide commercially significant catalysts (e.g., for ammonia production).

Although catalysts have been extensively investigated for many years, there remain specialty applications where conventional catalyst approaches can be substantially improved upon.

### SUMMARY

In this work, we consider the use of a catalyst in gas analysis applications. One example of such an application is removal of alcohols from a water vapor stream as preparation for subsequent water vapor analysis (e.g., water vapor concentration, isotopic ratio, etc.). Such sample preparation is especially relevant for optical gas analysis approaches, such as cavity ring-down spectroscopy (CRDS), cavity enhanced absorption spectroscopy (CEAS), etc. This relevance is because contaminant species (such as alcohols) can have optical absorption features that interfere with the absorption features of water vapor that provide the basis of the water vapor analysis. Similar considerations can apply to any other kind of gas analysis, because removing contaminant species is generally helpful.

We have found that there are special features of this catalyst application that have surprising implications for catalyst design. In particular, we have unexpectedly found that a catalyst configured as a plated wire is suitable for this application. Normally, a plated wire (i.e., a catalyst cladding surrounding a non-catalytic core) would be regarded as an unsuitable configuration because loss of catalyst during a process (e.g., by volatilization at a high temperature, as in ammonia production) is often significant. In such cases, the catalyst lifetime depends on the thickness d of the cladding layer and the catalyst cost depends on the cladding thickness d plus the core radius r. More specifically, for an ideal cylinder of length L, the catalyst cost will be proportional to the catalyst volume V=πL(2dr+d²). Thus, minimizing the cost for a given lifetime leads directly to the conclusion that the core radius should be zero (i.e., solid wires are preferred over plated wires).

We have found that in gas analysis applications, catalyst loss in operation is often not significant. As a result, significantly different catalyst configurations are of interest. In particular, we can consider maximizing the surface area of a fixed volume of catalyst in a plated wire configuration. Continuing the above ideal cylinder example, the surface area S=2πL(r+d). Here it is seen to be beneficial to increase r and decrease d as much as practical. In practice, the upper limit of r will be set to have the wires remain sufficiently flexible for formation into the desired configuration (e.g., a wooly configuration as in steel wool), and the lower limit of d will be set to provide substantially complete coverage of the wire core by the catalytically active cladding.

As described in greater detail below, it is important in practice to provide an intermediate layer between the non-catalytic core and the catalytic cladding in order to realize the benefits of the plated wire approach.

This approach provides significant advantages, which include:
1) Deposition of a catalyst on a high surface area flexible non-catalytic substrate reduces cost and provides a catalyst that is easy to handle. Thus high activity catalysts can be provided by using common materials for the substrate, thereby reducing the precious metal requirements.
2) Electrochemical or electroless deposition can provide good control of deposition parameters, such as layer thickness, composition, etc.
3) A flexible fibrous catalyst is significantly easier to handle than more common alternatives, such as woven or knotted wire gauze, and monoliths. Monoliths and wire gauze can't easily conform to various sample chamber configurations.
4) A flexible fibrous catalyst is also significantly easier to handle than a powder catalyst (details below).

### BRIEF DESCRIPTION OF THE DRAWINGS

FIG. 1 shows an example of catalytic processing for gas analysis.

FIG. 2 shows a wire cross section relating to the example of FIG. 1.

### DETAILED DESCRIPTION

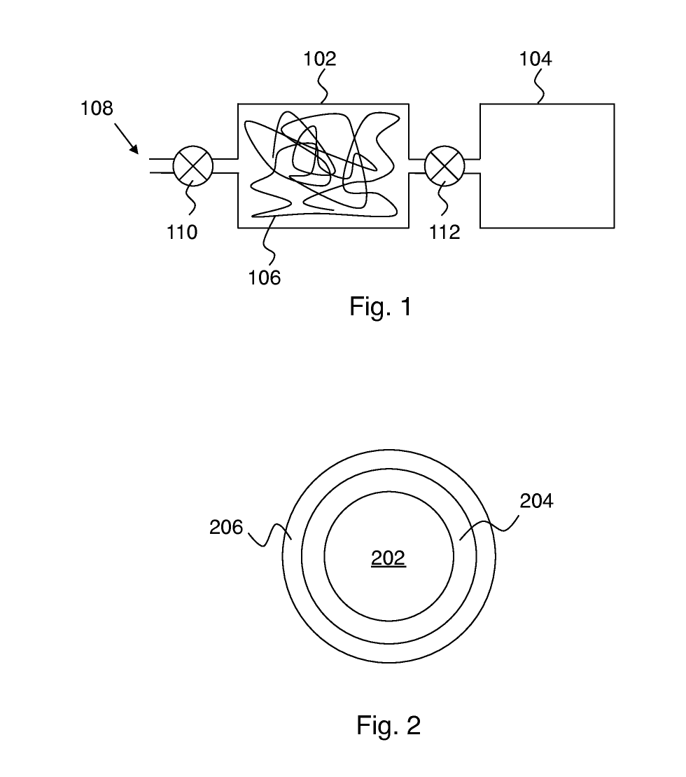

FIGS. 1 and 2 show an exemplary embodiment of the invention and its application to sample preparation for gas analysis. Here a gas sample enters a gas inlet 108 and is eventually received by a gas analysis instrument 104.

Along the way, the gas sample flows through a sample chamber 102 that includes a catalyst 106. Gas flow can be controlled by conventional means, shown schematically as flow controllers 110 and 112. Catalyst 106 is configured as a wooly fibrous structure having a catalytically active surface. This wooly fibrous structure includes one or more fibers. Preferably, catalyst 106 is flexible. As a result, it is advantageously capable of easily fitting into sample chambers 102 having various sizes/shapes.

FIG. 2 shows a cross section view of the fibers of catalyst 106. These fibers include a non-catalytic substrate 202, an intermediate layer 204 laterally disposed on substrate 202, and a catalytic layer 206 disposed on intermediate layer 204. Here catalytic layer 206 and intermediate layer 204 have different compositions. The non-catalytic substrate 202 can be any material that provides a suitable substrate for deposition of the subsequent layers as described in more detail below. Suitable materials for substrate 202 include, but are not limited to metal wool, metal wire, polymers, conductive polymers (e.g., polyaniline etc.) and carbon fiber. Preferably, the substrate fibers are thin enough to allow the catalyst to be both flexible and capable of filling sample chambers having various shapes. Preferably, the substrate is a low cost material that need not have exceptional properties or quality. Substrate 202 can be either electrically conductive or non-conductive.

Practice of the invention does not depend critically on the composition of catalyst layer 206. Any material having suitable catalytic activity can be employed. Suitable catalyst materials include, but are not limited to: Platinum, Rhodium, transition metals, post-transition metals, platinum group metals (Ru, Rh, Pd, Os, Ir, Pt), metal oxides and mixtures or alloys thereof.

Intermediate layer 204 is provided in order to improve the deposition of catalyst 206 on the substrate, e.g., by improving adhesion and/or improving the surface quality for deposition of catalyst 206. Low cost flexible substrates as considered above typically are not prepared with high quality surfaces which are required to achieve good adherence of the (typically noble) metals used for catalysis. Furthermore, the substrate is subject to mechanical and thermal stress which can cause the attached outer layer of catalyst to detach from the surface under such conditions. Providing an intermediate layer 204 effectively smoothes over the substrate surface and provides a continuous high quality surface which can improve adhesion of the catalyst material to the rest of the structure.

Such an intermediate adhesion layer 204 can be made of any metal which is particularly easy to electrodeposit. Suitable intermediate layer materials include nickel, chromium, transition metals, and mixtures or alloys thereof. Furthermore such an adhesion layer can be chosen to act as an intermediate with respect to lattice spacing.

If the surface termination of the substrate differs significantly in atomic spacing with the layer above it, the resulting lattice mismatch can build significant stress and result in irregular deposition or mechanical stress which can lead to detachment. An intermediate layer 204 can bridge the gap in lattice spacing between substrate and catalyst material to avoid these problems. For example in a substrate-intermediate-catalyst system where the substrate is Carbon, the intermediate layer is Nickel, and the catalyst is Platinum, the corresponding lattice spacings are 2.46 Å (C) <3.52 Å (Ni) <3.92 Å (Pt).

Finally intermediate layer 204 can also act as a diffusion barrier to prevent the catalyst 206 from migrating into the bulk of the substrate 202. Diffusion can occur for certain combinations of atoms and is accelerated by increased temperature which is typically required for catalyst operation. Correct choice of the intermediate layer can prevent such problems.

Although some embodiments of the invention are catalysts as described above (e.g., 106 on FIG. 1), other embodiments relate to catalysts in connection with gas analysis (e.g., the arrangement shown on FIG. 1). In such applications, practice of the invention does not depend critically on the kind of gas analysis being considered (e.g., concentration, isotopic ratio, specific species, etc.). Practice of the invention also does not depend critically on the type of gas analysis instrument 104 (e.g., mass spectrometry, chromatography, optical spectroscopy, etc.). It is expected that this approach will be especially helpful for optical gas analysis instruments (e.g., CRDS, CEAS, etc.), because such techniques often benefit from removal of contaminant species from the gas input to the gas analysis instrument 104. More generally, catalysts as considered herein are broadly applicable to any application for catalysts, especially to applications where loss of catalyst in operation is negligible.

A preferred approach for fabricating catalysts as described above is electrochemical or electroless deposition of both the intermediate layer 204 and the catalyst layer 206. Such deposition techniques include, but are not limited to: electroless plating, galvanostatic electrochemical deposition and potentiostatic electrochemical deposition. The commonly employed term electroplating can refer to galvanostatic electrochemical deposition and/or potentiostatic electrochemical deposition.

More specifically, an exemplary fabrication sequence includes the following steps:
1) providing a substrate configured as a wooly fibrous structure, where fibers of the wooly fibrous structure include a fiber core that is a non-catalytic material,
2) depositing an intermediate layer on the fiber core such that the intermediate layer is laterally disposed on the wire core,
3) depositing a catalytic layer on the intermediate layer, where the catalytic layer and the intermediate layer have different compositions.

As indicated above, the substrate can be electrically conductive or non-conductive. If a non-conductive substrate is employed, then electroless deposition can be used to deposit the intermediate layer. Since the intermediate layer is typically electrically conductive, deposition of the catalyst layer on the intermediate layer can be performed with any electrochemical or electroless deposition method.

Catalyst layer 206 can be formed by deposition of a catalytically active material. Alternatively, layer 206 can be formed by deposition of a catalyst precursor, followed by further chemical processing to convert the precursor to a catalytically active material (e.g., a metal precursor could be converted to a catalytically active metal oxide after deposition).

The present approach provides substantial advantages. To better appreciate these advantages, it is helpful to consider the gas analysis application in greater detail. In one example, we required a catalyst that would selectively oxidize alcohols present in a water vapor stream. However, this alcohol removal application differs significantly from known alcohol removal applications. One such application of alcohol removal is bakeries, which often emit significant amounts of ethanol. In some conventional approaches, volatile organic compound (VOC) control systems are installed at bakeries (which can include monolith catalyst blocks heated to ˜300 C to completely oxidize the alcohols). Monolith technology is literally inflexible and the catalyst container must be designed around the monolith. For analytical scale of use, the available pellets were too large and not very effective for the commercial catalyst and conditions which we evaluated. The primary problem was the pellet size and the design constraints imposed by the size. The most effective catalysts are generally precious metal catalysts which are coated onto powders, however these powders require an additional holder element to prevent the escape of fine particles into the downstream analytical instrument. Even if a suitable holder is provided for particulate catalysts, the dense packing of particles can decrease the gas volume in the catalyst chamber, thereby undesirably decreasing the residence time for gas in the catalyst chamber (assuming a fixed gas flow rate).

In contrast, the present approach is based on catalyst deposition by electrochemical or electroless means onto a flexible fibrous substrate. In one experiment the substrate was a fine steel wool (316 stainless steel about 00 grade), the intermediate layer was a 2.5 micron thick layer of nickel, (which helps adhesion as described above), and the catalyst layer was a 5 micron thick layer of rhodium. This structure was fabricated via electroplating. The resulting catalyst supported directly on steel wool easily conformed to the intended quartz tube holder and provided high surface area. This catalyst was easier to work with than conventional commercial Rhodium catalysts we acquired at significantly higher price, which led to improved performance in practice.

1. Apparatus comprising:
a catalyst configured as a wooly fibrous structure having a catalytically active surface, wherein the wooly fibrous structure comprises one or more fibers;
wherein the one or more fibers comprise:
a fiber core which is a non-catalytic substrate,
an intermediate layer laterally disposed on the fiber core, and
a catalytic layer disposed on the intermediate layer;
wherein the catalytic layer and the intermediate layer have different compositions.

2. The apparatus of claim 1, wherein the non-catalytic substrate is selected from the group consisting of: metal wool, metal wire, polymers, conductive polymers, and carbon fiber.

3. The apparatus of claim 1, wherein the intermediate layer is selected from the group consisting of: nickel, chromium, transition metals, and mixtures or alloys thereof.

4. The apparatus of claim 1, wherein the catalytic layer is selected from the group consisting of: platinum, rhodium, transition metals, post-transition metals, platinum group metals, metal oxides and mixtures or alloys thereof.

5. The apparatus of claim 1, wherein the intermediate layer has a lattice spacing that is between a lattice spacing of the substrate and a lattice spacing of the catalyst layer.

6. Apparatus comprising:
a gas analysis instrument; and
the apparatus of claim 1 configured to provide catalytic removal of contaminant species from a gas input to the gas analysis instrument.

7. The apparatus of claim 6, wherein the gas analysis instrument comprises an optical gas analysis instrument.

8. A method of making a catalyst, the method comprising
providing a substrate configured as a wooly fibrous structure, wherein the wooly fibrous structure comprises one or more fibers including a fiber core which is a non-catalytic material;
depositing an intermediate layer on the fiber core such that the intermediate layer is laterally disposed on the fiber core;
depositing a catalytic layer on the intermediate layer;
wherein the catalytic layer and the intermediate layer have different compositions.

9. The method of claim 8, wherein the depositing an intermediate layer is selected from the group consisting of: electroless plating, galvanostatic electrochemical deposition and potentiostatic electrochemical deposition.

10. The method of claim 8, wherein the depositing a catalytic layer is selected from the group consisting of: electroless plating, galvanostatic electrochemical deposition and potentiostatic electrochemical deposition.

11. The method of claim 8 wherein the depositing a catalytic layer on the intermediate layer comprises depositing a catalytic composition on the intermediate layer.

12. The method of claim 8 wherein the depositing a catalytic layer on the intermediate layer comprises depositing a precursor composition on the intermediate layer, followed by chemically processing the precursor composition to form the catalyst layer.
